(19) United States
(12) Patent Application Publication
(10) Pub. No.: US 2019/0131679 A1
(43) Pub. Date: May 2, 2019

(54) ENERGY STORAGE DEVICE ELECTROLYTE ADDITIVE

(71) Applicant: ZincNyx Energy Solutions, Inc., Vancouver (CA)

(72) Inventor: David Robert Bruce, Vancouver (CA)

(73) Assignee: ZincNyx Energy Solutions, Inc., Vancouver, BC (CA)

(21) Appl. No.: 16/094,396

(22) PCT Filed: Apr. 13, 2017
(86) PCT No.: PCT/CA2017/050468

§ 371 Date: Oct. 17, 2018

Related U.S. Application Data
(60) Provisional application No. 62/323,897, filed on Apr. 18, 2016.

(51) Int. Cl. H01M 12/06; H01M 6/04; H01M 6/50; H01M 12/02

(52) U.S. Cl. CPC H01M 12/06; H01M 12/02; H01M 6/5077; H01M 6/04

(57) ABSTRACT

Methods of regenerating a metal fuel in a regenerative electrochemical energy storage device are provided. The method includes: (a) providing an anode comprising oxidizable metal fuel; (b) regenerating dendritic metal fuel from the oxidized metal fuel, comprising enhancing dendrite formation of the metal fuel with an additive; and (c) storing the regenerated dendritic metal fuel, comprising suppressing corrosion of the regenerated particulate metal fuel with the additive. The regenerative electrochemical energy storage device may be regenerative metal-air fuel system or a rechargeable alkaline-metal battery. The metal fuel may be dendritic zinc.

### TECHNICAL FIELD

This disclosure relates, generally, to the field of metal-based electrochemical energy storage devices, such as, for example, rechargeable metal-air fuel cells, or rechargeable alkaline-metal batteries. One such example of a rechargeable metal-air fuel cell comprises a zinc-air fuel cell system. One such example of a rechargeable alkaline-metal battery comprises a zinc-manganese oxide battery. Specifically, this disclosure relates to electrolyte compositions of metal-based electrochemical energy storage devices. More specifically, this disclosure relates to processes for charging or recharging metal-based electrochemical energy storage devices.

### BACKGROUND

Metal-based electrochemical energy storage devices are ubiquitous in today's society taking the form of primary batteries, secondary (rechargeable) batteries, and metal-air fuel cells.

Metal-air fuel cells provide high energy efficiency and yet are low cost with low environmental impact. The zinc-air fuel cell is an example of a metal-air fuel cell. In a metal-air fuel cell, a metal species is provided as fuel, air is provided as an oxygen source, and an aqueous alkaline solution, such as potassium hydroxide (KOH), is provided as an electrolyte. When an electric circuit is closed, the metal fuel is consumed via an anodic or negative electrode reaction. One such reaction for zinc in a KOH electrolyte is:

Zn+4KOH→K₂Zn(OH)₄+2K⁺+2e (1) E°=1.216 V

As shown above, zinc metal is consumed as it reacts with KOH. As the zinc metal is consumed potassium zincate is formed (K₂Zn(OH)₄) and electrons are released to an anode current conductor. Equivalent anodic oxidation processes also occur in primary and secondary battery technologies.

In metal-air fuel cells oxygen is supplied to the cathode and reacts with H₂O and electrons on the cathode to form hydroxyl ions (OH). The cathode or positive electrode reaction is therefore:

½O₂+H₂O+2e→2OH⁻ (2) E⁰=0.401 V

In primary and secondary batteries the cathodic reaction consists of the reduction of an alternate chemical species, usually in the form of a solid oxide. An example of a cathode or positive electrode reaction in alkaline-metal batteries is therefore:

2MnO₂+H₂O+2e→Mn₂O₃+2OH⁻ (3) E⁰=0.15 V

The hydroxyl ions from either equation (2) or equation (3) and the potassium ions from equation (1) then react with zinc metal again in equation (1) at the anode.

According to the above reaction schemes, the oxidation of zinc and the reduction of oxygen or other species causes a change of chemical energy into electrical energy. For this reaction to proceed over long periods of time there must be a continuous supply of zinc metal and oxidant as well as a means of constant flow of electrons from the system, i.e., connection to a load.

In previous zinc-air implementations the metal electrodes have had a fixed quantity of zinc, limiting their available energy and having rechargeability drawbacks due to size augmentation of the electrodes upon cycling. Decreases in the electrode area leads to a decrease in power of the fuel cell system.

In previous battery implementations the metal electrodes had an amorphous shape, and would suffer from shape change due to augmentation of the electrodes upon cycling. Decreases in the electrode area leads to a decrease in power of the fuel cell system.

The use of dendritic structures in the in operando formation of advanced zinc anodes in alkaline-zinc battery technology is a state-of-the-art strategy to create a battery capable of indefinite cycle life. [Chamoun et al., NPG Asia Materials (2015) 7, e178; doi:10.1038/am.2015.32]

Also, and in accordance with the exemplary reaction scheme described, above typical metal-air fuel cells, such as zinc-air fuel cells, are not without inefficiencies. For example, where zinc is used as the metal fuel, deposition of zincate on the surface of the zinc particles may cause a slow-down of reaction kinetics, passivation of zinc particles, and eventually shut down of the cell.

Further, reaction of the metal fuel with an alkaline electrolyte (e.g. KOH) results in corrosion of the metal fuel, and thus reduces the efficiency and cycle life of the metal-based electrochemical energy storage devices. A zinc anode, for example, is prone to corrosion when in contact with an alkaline electrolyte at or above room temperature. Corrosion of a metal anode, such as a zinc anode, results in the formation of oxidized zinc products thereby decreasing the availability of active zinc and generation of hydrogen gas, as detailed in the reaction below:

Zn+2H₂O+2KOH→K₂Zn(OH)₄+H₂ (4)

There remains a need for improved regenerative metal-based electrochemical energy storage devices.

### SUMMARY

The inventions described herein have many aspects, some of which relate to methods for regenerating the metal fuel of an electrochemical cell.

In some aspects, methods of regenerating particulate metal fuel in a regenerative metal-air fuel system are provided. The regenerative metal-air fuel system typically includes a metal-air fuel cell, an electrolyzer, and a storage means. The metal-air fuel cell, the electrolyzer and the storage means are in fluid communication, and particulate metal fuel suspended in an electrolyte and circulates through the system. One or more additives are added to the electrolyte to both enhance dendrite formation of the particulate metal fuel as the metal fuel is regenerated in the electrolyzer and suppress corrosion of the regenerated particulate metal fuel.

In some aspects, methods of regenerating a dendritic metal fuel structure in a rechargeable alkaline-metal battery are provided. The rechargeable alkaline-metal battery typically includes an integrated metallic anode and metallic oxide or sulfide cathode in fluid communication by a common electrolyte. The anode and cathode are commonly electrically isolated by an insulating separator layer. One or more additives are added to the electrolyte to both enhance dendrite formation of the metal fuel as the metal fuel is regenerated and suppress corrosion of the regenerated metal fuel structure.

In some aspects, methods of regenerating a metal fuel in a regenerative electrochemical energy storage device are provided. The method comprises: (a) providing an anode comprising oxidizable metal fuel; (b) regenerating dendritic metal fuel from the oxidized metal fuel, comprising enhancing dendrite formation of the metal fuel with an additive; and (c) storing the regenerated dendritic metal fuel, comprising suppressing corrosion of the regenerated particulate metal fuel with the additive. The additive may enhance dendrite formation of the metal fuel with a reduction in overpotential of greater than 1 mV compared to an equivalent method excluding the additive. The additive may suppress corrosion of the regenerated dendritic metal fuel by greater than 0.001 mLemin⁻¹ compared to an equivalent method excluding the additive. The additive may have low polarity. The additive may have a polarity of 0-4 debyes, of 0-2 debyes, or of 0-1 debye. The additive may comprise phosphorus. The additive may comprise a phosphate, a phosphite, or a pyrophosphate. The additive may be Kalipol 4KP or Kalipol E-19. The additive may be provided in a concentration range of 10 ppm to 50,000 ppm, 1000 ppm to 10,000 ppm, or 2500 ppm to 7500 ppm. The dendritic metal fuel may be dendritic zinc.

The regenerative electrochemical energy storage device may comprise: a cathode; an anode comprising an anode current collector; and an anode chamber at least partially defined by the cathode and the anode current collector; wherein the anode current collector is in contact with a plurality of dendritic particles suspended in an electrolyte. The regenerative electrochemical energy storage device may comprise a metal air fuel cell.

The regenerative electrochemical energy storage device may comprise: a cathode; an anode comprising an anode current collector; and an anode chamber at least partially defined by the cathode and the anode current collector; wherein the anode current collector is in contact with a dendritic metal network in an electrolyte. The regenerative electrochemical energy storage device may comprise an alkaline metal battery or a metal air fuel cell.

The regenerative electrochemical energy storage device may comprise a regenerative metal fuel system. The regenerative metal fuel system may comprise a fuel cell, an electrolyzer and a storage means. Each of the fuel cell, the electrolyzer and the storage means may be in fluid communication and connected by a conduit. In this way, as a metal fuel and/or an electrolyte are consumed they may periodically be replaced by transmitting fresh components through the regenerative metal fuel system.

The regenerative electrochemical energy storage device may comprise a regenerative metal fuel system. The regenerative metal fuel system may comprise a reversible fuel cell in which the system components are static and the metal fuel is regenerated in its original location.

The regenerative electrochemical energy storage device may comprise a regenerative metal fuel system. The regenerative metal fuel system may comprise an alkaline secondary battery storage means in which the system components are static and the metal fuel is regenerated in its original location.

The foregoing discussion merely summarizes certain aspects of the invention and is not intended, nor should it be construed, as limiting the invention in any way.

### BRIEF DESCRIPTION OF DRAWINGS

The drawings show non-limiting embodiments of this disclosure.

FIG. 1 is a schematic view of a metal-air fuel cell system according to an embodiment of the invention.

FIG. 2 is a schematic view of a secondary battery system according to an embodiment of the invention.

FIGS. 3A to 3F are optical micrographs of experiments to regenerate metal fuel in various electrolyte compositions.

FIG. 4 is a table indicating the lengths of zinc dendrites formed in the experiments shown in FIGS. 3A to 3F.

FIG. 5 is a graph indicating the hydrogen gas generated by the corrosion of zinc dendrites in various electrolyte compositions.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The term “fuel cell’ as used herein refers to an electrochemical device as would be understood by a person skilled in the art. The term “fuel cell” includes, without limitation, devices known as “flow batteries” and similar terminology.

The term “rechargeable battery” as used herein refers to an electrochemical device as would be understood by a person skilled in the art. The term “rechargeable battery” includes, without limitation, devices known as “secondary batteries” and similar technology.

The term “additive” as used herein may comprise one or more components. While the exact nature of the additive may be discussed in the context of certain embodiments herein, the key features of certain embodiments with commercial utility are that the additive is effective to suppress corrosion of the metal fuel and enhance the formation the metal fuel into a dendritric form. The additive may further be effective to enhance formation of the metal fuel into a dendritic form at a lower cell overpotential.

A first aspect of the disclosure is providing a high energy efficiency metal-air fuel cell. For example, in some embodiments a metal-air fuel cell accommodating a bed of particulate metal fuel is provided. In some embodiments only a single fuel cell is provided. In other embodiments a plurality of fuel cells are provided as a fuel cell stack. It will be appreciated by persons skilled in the art that where only a single fuel cell is described that description may similarly apply to a plurality of fuel cells provided as a fuel cell stack, and vice versa.

In the aforementioned bed of particulate metal fuel, the metal particles are in contact with each other and with the anode current collector. Thus the total surface area of metal particles contributing to the electrode reaction and generation of electrical current is much greater, in turn leading to higher energy efficiency.

In some embodiments, the regenerative metal fuel system uses an electrolyte that may be alkaline, such as an aqueous alkaline hydroxide. In some embodiments, the aqueous alkali hydroxide may be aqueous potassium hydroxide (KOH) or aqueous sodium hydroxide (NaOH). In some embodiments, the concentration of the aqueous alkali hydroxide may range from 5% to 60% by weight, or 20% to 50% by weight, or 30% to 45% by weight. In other embodiments, the regenerative metal fuel system uses an electrolyte that may be non-alkaline or non-aqueous.

In some embodiments, the metal particles may be zinc, aluminum, beryllium, calcium, iron, lithium, magnesium, sodium, titanium, or a mixture of such metals. In some embodiments, the metal particles may range in size from 5 nm to 1 mm, or 5 nm to 0.5 mm, or 5 nm to 0.3 mm.

A second aspect of the disclosure is providing a high energy efficiency, long lasting alkaline-metal secondary battery. For example, in some embodiments an alkaline-metal secondary battery accommodating an anode of dendritically formed metal fuel is provided.

In the aforementioned anode of dendritically formed metal fuel, the metal is in networked dendritic contact and is also in contact with the anode current collector. Thus the metal anode contributing to the electrode reaction and generation of electrical current has a continuous metal contact and the electrical conductivity is much greater, in turn leading to higher energy efficiency.

In the aforementioned anode of dendritically formed metal fuel, when recharged, the metal reforms the networked dendritic structure and also remains in contact with the anode current collector. Thus the metal anode contributing to the electrode reaction and generation of electrical current has an unaltered cyclical recharged structure, in turn leading to improved device lifetime.

In some embodiments, the alkaline-metal secondary battery uses an electrolyte that may be alkaline, such as an aqueous alkaline hydroxide. In some embodiments, the aqueous alkali hydroxide may be aqueous potassium hydroxide (KOH) or aqueous sodium hydroxide (NaOH). In some embodiments, the concentration of the aqueous alkali hydroxide may range from 5% to 60% by weight, or 20% to 50% by weight, or 30% to 45% by weight. In other embodiments, the alkaline-metal secondary battery uses an electrolyte that may be non-alkaline or non-aqueous.

In some embodiments, the metal anode may be zinc, aluminum, beryllium, calcium, iron, lithium, magnesium, sodium, titanium, or a mixture of such metals. In some embodiments, the metal dendritic structures may range in size from 5 nm to 10 mm, or 5 nm to 0.5 mm, or 5 nm to 0.3 mm.

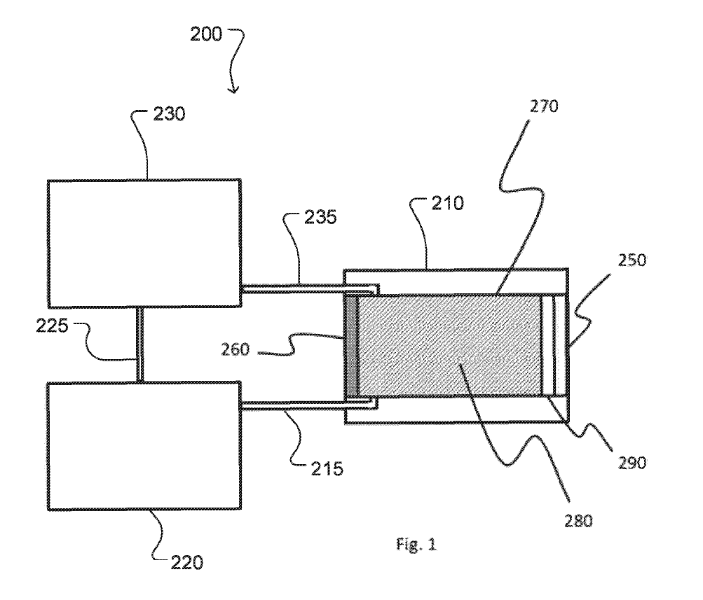

The operation of the regenerative metal-air fuel system will now be described. FIG. 1 shows regenerative metal-air fuel system 200 according to one embodiment. According to this embodiment, system 200 includes a metal-air fuel cell 210, an electrolyzer 220 and a storage means 230. Fuel cell 210 may for example comprise a fuel cell. Fuel cell 210 may also comprise a plurality of fuel cells to form a fuel cell stack. Fuel cell 210 typically comprises a cathode 250, and anode comprising of an anode current collector 260, an anode chamber 270 at least partially defined by the cathode and anode current collector, and a plurality of dendritic metal particles in an electrolyte 280. The cathode 250 and plurality of dendritic metal particles may be separated by a separator 290.

Within the fuel cell 210 when electricity is required particulate metal fuel 280 contained within is reacted with air. Additional fuel can be supplied to fuel cell 210 from storage means 230 by conduit 235 by a transmission means such as a pump. The transmission means could be positioned in storage means 230 to push the particulate metal fuel through conduit 235 into fuel cell 210. Alternatively, the transmission means could be positioned in fuel cell 210 and draw the particulate metal fuel in storage means 230 through conduit 235 into fuel cell 210.

Spent metal fuel in the form of the oxidized metal product from fuel cell 210, for example potassium zincate, is transferred to the storage means 230 by conduit 235. The oxidized metal fuel in electrolyte suspension may be directed from fuel cell 210 to the storage means 230 by a transmission means such as a pump. The transmission means could be positioned in fuel cell 210 to push the oxidized metal fuel through conduit 235 into storage means 230. Alternatively, the transmission means could be positioned in storage means 230 and draw the oxidized metal fuel in fuel cell 210 through conduit 235 into storage means 230.

As the particulate metal fuel, such as particulate lithium or zinc, becomes oxidized after having generated power in fuel cell 210, fuel cell 210 may run out of its power source and stop working. To regenerate the oxidized metal fuel, the oxidized metal fuel in electrolyte is directed from storage means 230 to electrolyzer 220 via conduit 225. The oxidized metal fuel in electrolyte suspension may be directed from storage means 230 to the electrolyzer 220 by a transmission means such as a pump. The transmission means could be positioned in storage means 230 to push the oxidized metal fuel through conduit 225 into electrolyzer 220. Alternatively, the transmission means could be positioned in electrolyzer 220 and draw the oxidized metal fuel in storage means 230 through conduit 225 into electrolyzer 220.

The generated particulate metal fuel, regenerated in electrolyzer 220 can be supplied to storage means 230 via conduit 225. The dendritic metal fuel in electrolyte suspension may be directed from electrolyser 220 to the storage means 230 by a transmission means such as a pump. The transmission means could be positioned in electrolyzer 220 to push the particulate metal fuel through conduit 225 into storage means 230. Alternatively, the transmission means could be positioned in storage means 230 and draw the particulate metal fuel in electrolyzer 220 through conduit 225 into storage means 230.

In an example embodiment, the oxidized metal fuel may be regenerated in electrolyzer 220 by applying 200 mA/cm² current density for 3 minutes at 50° C. In some embodiments, the current density may range from 50 mA/cm² to 3000 mA/cm², or 100 mA/cm² to 1000 mA/cm², or 150 mA/cm² to 300 mA/cm². In some embodiments, the growth cycle duration may range from 30 s to 30 min, or 1 min to 5 min, or 2 min to 4 min. In some embodiments, the temperature may range from −30° C. to 120° C., or 30° C. to 100° C., or 50° C. to 90° C. It will be appreciated by those skilled in the art that regeneration of the metal fuel may vary from the conditions described above in terms of current density, duration of regeneration cycle, and the like.

In some embodiments of regenerative metal-air fuel system 200 the particulate metal fuel comprises dendritic zinc. Regeneration of dendritic zinc in a typical electrolyzer typically occurs at high cathodic overpotential, which introduces system inefficiency. In an example embodiment, a high cathodic overpotential that would promote dendritic growth may be 250 mA. In some embodiments, the cathodic overpotential for dendritic growth may range from 50 mA to 2000 mA, or 75 mA to 1000 mA, or 100 mA to 300 mA. It will be appreciated by those skilled in the art that the overpotential required to promote regeneration of dendritic metal fuel particles may vary from the conditions described above in terms of current density, duration of regeneration cycle, and the like. It is also obvious to those skilled in the art that a low cathodic overpotential is an overpotential that is smaller than the high cathodic overpotential described above in equivalent system regeneration conditions.

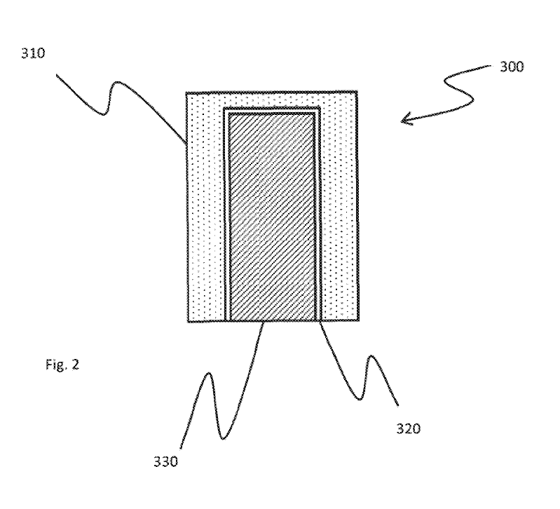

The operation of the rechargeable alkaline-metal battery will now be described. FIG. 2 shows rechargeable alkaline-metal battery 300 according to one embodiment. According to this embodiment, system 300 includes a metallic oxide or sulfide cathode 330, and anode comprising of an anode current collector 340, an anode chamber 350 at least partially defined by the cathode and anode current collector, and a dendritic metal network in an electrolyte 310. The cathode 310 and dendritic metal network may be separated by a separator 320.

Within the battery the spent metal fuel is depleted in the form of the oxidized metal product from anode 310, for example potassium zincate, and a corresponding depletion of the metal oxide or sulfide in the form of reduction of the cathode 330, for example manganese (III) oxide, occurs. All reactants and products remain in system 300.

To regenerate the oxidized metal fuel, the oxidized metal fuel in electrolyte is reformed on anode 310 in a dendritic network of interconnected particles. Correspondingly the metallic oxide or sulphide cathode is re-oxidized on cathode 330.

The inventor has determined that in a metal-air system, system efficiency may be enhanced by regenerating dendritic zinc fuel in an electrolyzer at low cell overpotential. In some embodiments one or more additives may be added to the oxidized metal fuel in electrolyte suspension in electrolyzer 220 to lower cathodic overpotential at which a dendritic metal fuel, such as dendritic zinc, may be regenerated.

In some embodiments the additive may be a phosphorus-containing compound, such as phosphates, phosphites, or pyrophosphates. In example embodiments, the additive may be Kalipol 4KP (K₄P₂O₇) or Kalipol E-19 (i.e., a 20-20-60 blend of pyro-, tripoly-, and higher poly-phosphate species).

The inventor has determined that in an alkaline-metal battery, system efficiency and device longevity may be enhanced by regenerating dendritic zinc anodes at low cell overpotential. In some embodiments an additive may be added to the oxidized metal fuel-electrolyte mixture in anode 310 to lower cathodic overpotential at which a dendritic metal structure, such as dendritic zinc, may be regenerated. In some embodiments the additive may be a phosphorus-containing compound, such as phosphates, phosphites, or pyrophosphates. In example embodiments, the additive may be Kalipol 4KP (K₄P₂O₇) or Kalipol E-19 (i.e., a 20-20-60 blend of pyro-, tripoly-, and higher poly-phosphate species).

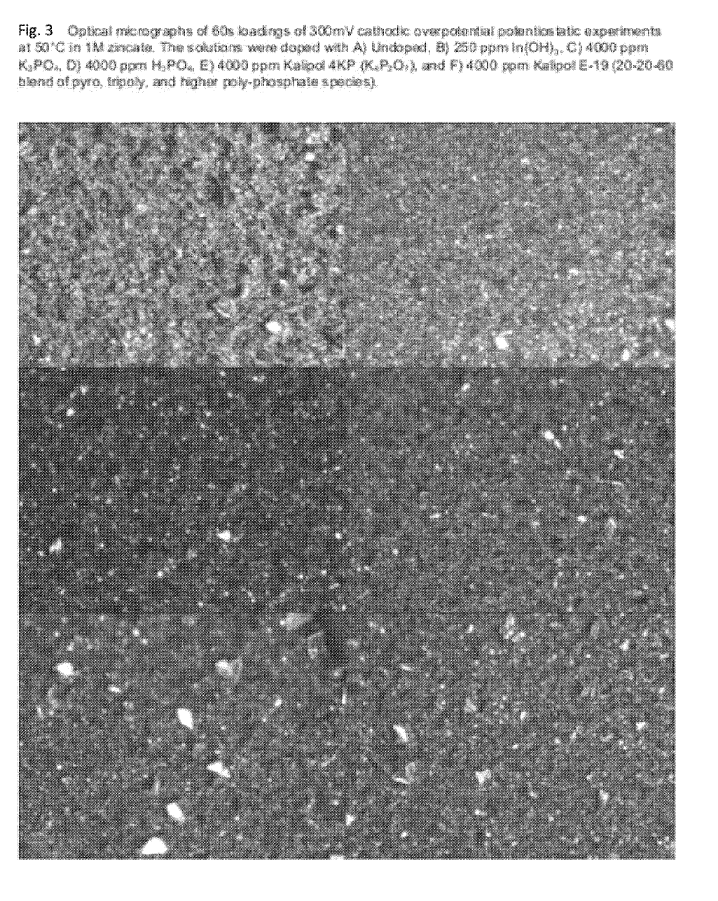

As shown in FIG. 3, optical micrographs of a 60s regeneration cycle in 300 mV cathodic overpotential potentiostatic experiments at 50° C. in 1M zincate show that formation of dendritic zinc is enhanced when the solution is doped with 4,000 ppm H₃PO₄, 4,000 ppm Kalipol 4KP or 4,000 ppm Kalipol E-19 relative to undoped solutions or solutions doped with 250 ppm ln(OH)₃ or 4,000 ppm K₃PO₄.

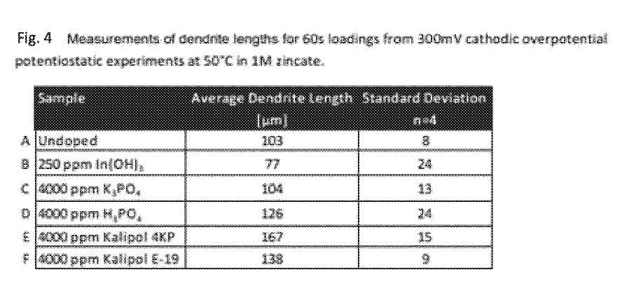

As shown in FIG. 4, zinc dendrites formed according to the reaction conditions indicated above have a higher average length when formed in solutions doped with 4,000 ppm H₃PO₄, 4,000 ppm Kalipol 4KP and 4,000 ppm Kalipol E-19 relative to undoped solutions or solutions doped with 250 ppm ln(OH)₃ or 4,000 ppm K₃PO₄.

The person skilled in the art will appreciate that enhancement of dendrite formation of a metal fuel is not limited to the chemical species described above. In some embodiments, the chemical additive may comprise inorganic oxides, nitrides, sulphides, nitrates, sulphates, silicates, borates, or organic molecules. In some embodiments, additives having a low polarity may be preferred. For those skilled in the art the polarity is defined as the expression of a dipole moment in the additive molecule due to uneven charge distribution across its constituent atomic arrangement.

Accordingly, any chemical species that fulfills the role of effectively enhancing the formation of particulate metal fuel into a dendritic form at low cell overpotential is encompassed by the present disclosure.

The person skilled in the art will also appreciate that the concentration of additive may deviate from the example values. In some embodiments, the concentration of additive may range from 10 ppm to 50,000 ppm, or 1000 to 10,000 ppm, or 2500 to 7500 ppm, or about 4000 ppm. Moreover, compositions of the additives will also vary in range depending on the active surface area of the particulate metal fuel used, but would typically range between 0.001% and 5% by weight of the metal component present in the electrolyte.

The regenerated particulate metal fuel in electrolyte suspension may be stored in storage means 230 until the particulate metal fuel of fuel cell 210 is consumed. In some embodiments the regenerated particulate metal fuel in electrolyte suspension may be stored inside storage means 230 for a long period of time. Depending on the nature of the electrolyte the regenerated particulate metal fuel may corrode. For example, zinc particles will corrode in an alkaline electrolyte.

The regenerated metal anode in rechargeable alkaline-metal battery may be stored until the metal fuel of anode 310 is consumed. In some embodiments the regenerated metal fuel may be stored for a long period of time. Depending on the nature of the electrolyte the regenerated particulate metal fuel may corrode. For example, zinc particles will corrode in an alkaline electrolyte.

In some embodiments, the additive used to enhance the regeneration of a dendritic metal fuel, such as dendritic zinc, at lower cell overpotential in electrolyzer 220 may simultaneously suppress corrosion (and resulting hydrogen generation) of the regenerated dendritic metal fuel in storage means 230. Accordingly, in some embodiments the additive may be a phosphorus-containing compound, such as phosphates, phosphites, or pyrophosphates. In example embodiments, the additive may be Kalipol 4KP (K₄P₂O₇) or Kalipol E-19 (i.e., a 20-20-60 blend of pyro-, tripoly-, and higher poly-phosphate species).

In some embodiments, the additive used to enhance the regeneration of a dendritic metal anode, such as dendritic zinc, at lower cell overpotential at anode 310 may simultaneously suppress corrosion (and resulting hydrogen generation) of the regenerated dendritic metal fuel anode 310. Accordingly, in some embodiments the additive may be a phosphorus-containing compound, such as phosphates, phosphites, or pyrophosphates. In example embodiments, the additive may be Kalipol 4KP (K₄P₂O₇) or Kalipol E-19 (i.e., a 20-20-60 blend of pyro-, tripoly-, and higher poly-phosphate species).

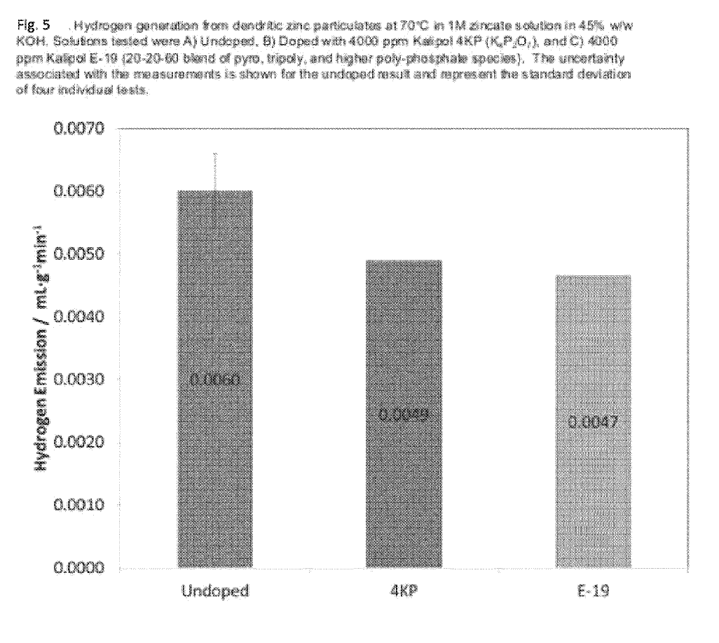

FIG. 5 shows that addition of 4,000 ppm Kalipol 4KP or 4,000 ppm Kalipol E-19 into a 1M zincate solution in 45% w/w KOH resulted in decreased hydrogen generation from dendritic zinc particles at 70° C. in comparison to an undoped 1M zincate solution in 45% w/w KOH.

As above, the person skilled in the art will appreciate that suppressing corrosion of the dendritic metal fuel (as measured by the generation hydrogen gas) is not limited to the chemical species described above. In some embodiments, the chemical additive may comprise inorganic oxides, nitrides, sulphides, nitrates, sulphates, silicates, borates, or organic molecules. In general, additives having a low polarity may be preferred. In some embodiments, the additive may have a polarity of 0 to 4 debyes, or 0 to 2 debyes, or 0 to 1 debye. In some embodiments, any chemical species that fulfills the role of effectively suppressing corrosion of the dendritic metal fuel (as measured by the generation hydrogen gas) may be used.

The person skill in the art will also appreciate that the concentration of additive may deviate from the disclosed values. In some embodiments, the concentration of additive may range from 10 to 50,000 ppm, or 1000 to 10,000 ppm, or 2500 to 7500 ppm, or about 4000 ppm. Moreover, compositions of the additives will also vary in range depending on the active surface area of the particulate metal fuel in question, but would typically range between 0.001% and 5% by weight of the metal component present in the electrolyte.

Where a component (e.g. cathode, anode current collector, transmission means etc.) is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

This application is intended to cover any variations, uses, or adaptations of the invention using its general principles. Further, this application is intended to cover such departures from the present disclosure as come within known or customary practice in the art to which this invention pertains and which fall within the limits of the appended claims. Accordingly, the scope of the claims should not be limited by the preferred embodiments set forth in the description, but should be given the broadest interpretation consistent with the description as a whole.

1. A method of regenerating a metal fuel in a regenerative electrochemical energy storage device, the method comprising:
(a) providing an anode comprising oxidizable metal fuel;
(b) regenerating dendritic metal fuel from the oxidized metal fuel, comprising enhancing dendrite formation of the metal fuel with an additive; and
(c) storing the regenerated dendritic metal fuel, comprising suppressing corrosion of the regenerated particulate metal fuel with the additive.

2. A method according to claim 1 wherein the additive enhances dendrite formation of the metal fuel with a reduction in overpotential of greater than 1 mV compared to an equivalent method excluding the additive.

3. A method according to claim 1 wherein the additive suppresses corrosion of the regenerated dendritic metal fuel by greater than 0.001 mLg⁻¹min⁻¹ compared to an equivalent method excluding the additive.

4. A method according to claim 1 wherein the additive has low polarity.

5. A method according to claim 1 wherein the additive has a polarity of 0-4 debyes.

6. A method according to claim 5 wherein the additive has a polarity of 0-2 debyes.

7. A method according to claim 5 wherein the additive has a polarity of 0-1 debye.

8. A method according to claim 1, wherein the additive comprises phosphorus.

9. A method according to claim 8 wherein the additive comprises a phosphate, a phosphite, or a pyrophosphate.

10. A method according to claim 9 wherein the additive is Kalipol 4KP or Kalipol E-19.

11. A method according to claim 1 wherein the additive is provided in a concentration range of 10 ppm to 50,000 ppm.

12. A method according to claim 11 wherein the additive is provided in a concentration range of 1000 ppm to 10,000 ppm.

13. A method according to claim 12 wherein the additive is provided in a concentration range of 2500 ppm to 7500 ppm.

14. A method according to claim 1 wherein the dendritic metal fuel is dendritic zinc.

15. A method according to claim 1 wherein the regenerative electrochemical energy storage device comprises:
a cathode;
an anode comprising an anode current collector; and
an anode chamber at least partially defined by the cathode and the anode current collector;
wherein the anode current collector is in contact with a plurality of dendritic particles suspended in an electrolyte.

16. A method according to claim 15 wherein the regenerative electrochemical energy storage device comprises a metal air fuel cell.

17. A method according to claim 1 wherein the regenerative electrochemical energy storage device comprises:
a cathode;
an anode comprising an anode current collector; and
an anode chamber at least partially defined by the cathode and the anode current collector;
wherein the anode current collector is in contact with a dendritic metal network in an electrolyte.

18. A method according to claim 17 wherein the regenerative electrochemical energy storage device comprises an alkaline metal battery.

19. A method according to claim 17 wherein the regenerative electrochemical energy storage device comprises a metal air fuel cell.

20. (canceled)
